(19) United States
(12) Patent Application Publication
(10) Pub. No.: US 2019/0315235 A1
(43) Pub. Date: Oct. 17, 2019

(54) POWER SUPPLY EXCHANGE SYSTEM FOR USE WITH AN UNMANNED AERIAL VEHICLE

(71) Applicant: Ryan KUNG, Kaohsiung City (TW)

(72) Inventor: Ryan KUNG, Kaohsiung City (TW)

(21) Appl. No.: 16/182,008

(22) Filed: Nov. 6, 2018

(30) Foreign Application Priority Data
Apr. 13, 2018 (TW) 107204805

(51) Int. Cl. B60L 11/18; B64F 1/36

(52) U.S. Cl. CPC B60L 11/1822; B60L 2200/10; B64F 1/362; B60L 11/1825

(57) ABSTRACT

A power supply and exchange system includes a supporting unit and a power supply unit. The supporting unit defines a connecting opening, and includes a rotatable holding seat defining multiple angularly spaced apart receiving slots. The power supply unit includes multiple energy modules detachably received in the receiving slots. A mounting seat of an unmanned aerial vehicle is mounted with one of the energy modules. The unmanned aerial vehicle can be positioned to allow the mounting seat to be aligned with the connecting opening for releasing the one of the energy modules, followed by rotating the holding seat for another one of the energy modules to be mounted to the mounting seat.

### CROSS-REFERENCE TO RELATED APPLICATION

This application claims priority of Taiwanese Utility Model Patent Application No. 107204805, filed on Apr. 13, 2018.

### FIELD

The disclosure relates to a power supply exchange system, and more particularly to a power supply exchange system for use with an unmanned aerial vehicle.

### BACKGROUND

With the development and miniaturization of electronic controllers and power elements, more and more unmanned aerial vehicles (UAVs) are manufactured and widely used for various applications. E-commerce and logistic companies utilize UAVs to transport goods. UAVs are also used for aerial photography, farming (such as aerial spray of pesticides, fertilizers and so on), etc.

A durable power supply system is critical for continuous and smooth operation of a UAV. Besides liquid fueling system, most of the UAVs use solid state power supply system, which may contain batteries. Conventionally, a UAV must land completely before the power supply system thereof can be manually replaced. This configuration requires excess manpower to perform the power supply system replacement process, and the replacement process is rather time consuming. In addition, the workers may damage the UAV when removing the power supply system, and may not properly install the power supply system to the UAV.

Automated power supply exchange systems are developed to solve the abovementioned problems. However, robotic arms, which are used in the automated power supply exchange systems, are expensive and requires sophisticated control module to perform the exchange process.

### SUMMARY

Therefore, an object of the disclosure is to provide a power supply exchange system for use with an unmanned aerial vehicle that can alleviate at least one of the drawbacks of the prior art.

According to an aspect of the present disclosure, a power supply exchange system is adapted for use with an unmanned aerial vehicle including a mounting seat.

The power supply exchange system includes a supporting unit, a transmission unit and a power supply unit. The supporting unit includes an outer shell that defines a connecting opening, and a holding seat that is rotatably connected to the outer shell and that defines a plurality of angularly spaced apart receiving slots. The transmission unit is connected to the outer shell and is operable to drive rotation of the holding seat to align the connecting opening with a selected one of the receiving slots. The power supply unit includes a plurality of energy modules that are detachably and correspondingly received in the receiving slots.

When operating the unmanned aerial vehicle, one of the energy modules is adapted to be detachably mounted to the mounting seat of the unmanned aerial vehicle for providing power to the unmanned aerial vehicle. When the power provided by the one of the energy modules is to be consumed, the unmanned aerial vehicle is positioned to allow the mounting seat to be aligned with the connecting opening, followed by releasing the one of the energy modules into a corresponding one of the receiving slots, followed by operating the transmission unit to rotate the holding seat such that another one of the energy modules is aligned with the connecting opening and is adapted to be detachably mounted to the mounting seat of the unmanned aerial vehicle for providing power to the unmanned aerial vehicle.

### BRIEF DESCRIPTION OF THE DRAWINGS

Other features and advantages of the disclosure will become apparent in the following detailed description of the embodiment with reference to the accompanying drawings, of which:

FIG. 1 is a schematic view of an embodiment of a power supply exchange system according to the present disclosure, which is used with an unmanned aerial vehicle for providing one of energy modules to the unmanned aerial vehicle;

FIG. 2 is a partially exploded perspective view of the embodiment, wherein an outer shell of the embodiment is omitted;

FIG. 3 is a sectional view of the embodiment;

FIG. 4 is a schematic view of a part of a power supply unit of the embodiment;

FIG. 5 is a schematic view showing the unmanned aerial vehicle being operated to dock at the embodiment;

FIG. 6 is a schematic view showing the unmanned aerial vehicle docks at the embodiment, and releases the one of the energy modules;

FIG. 7 is a schematic view showing rotation of a holding seat of the embodiment, such that another one of the energy modules is rotated to align with the unmanned aerial vehicle;

FIG. 8 is a schematic view showing the another one of the energy modules being attached to the unmanned aerial vehicle, and the unmanned aerial vehicle undocking from the embodiment;

FIG. 9 is a schematic view showing two of the embodiments being provided for a variation of the unmanned aerial vehicle according to the present disclosure;

FIG. 10 is a schematic view of another variation of the unmanned aerial vehicle according to the present disclosure; and

FIG. 11 is a schematic top view of the another variation of the unmanned aerial vehicle according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

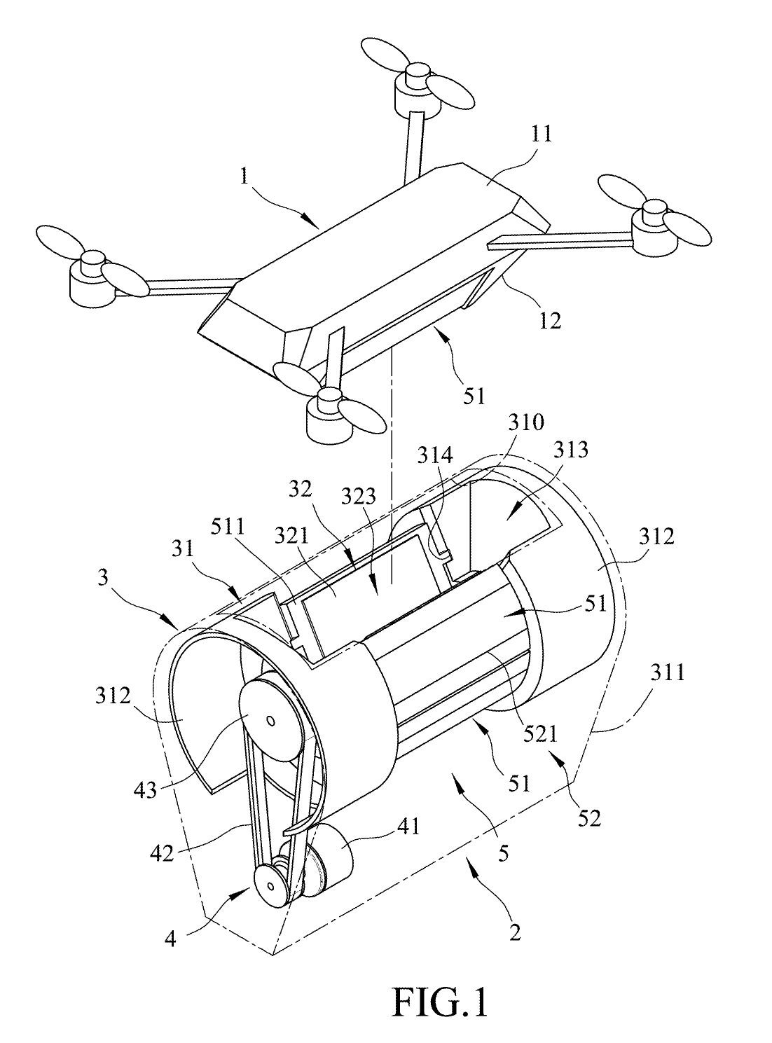

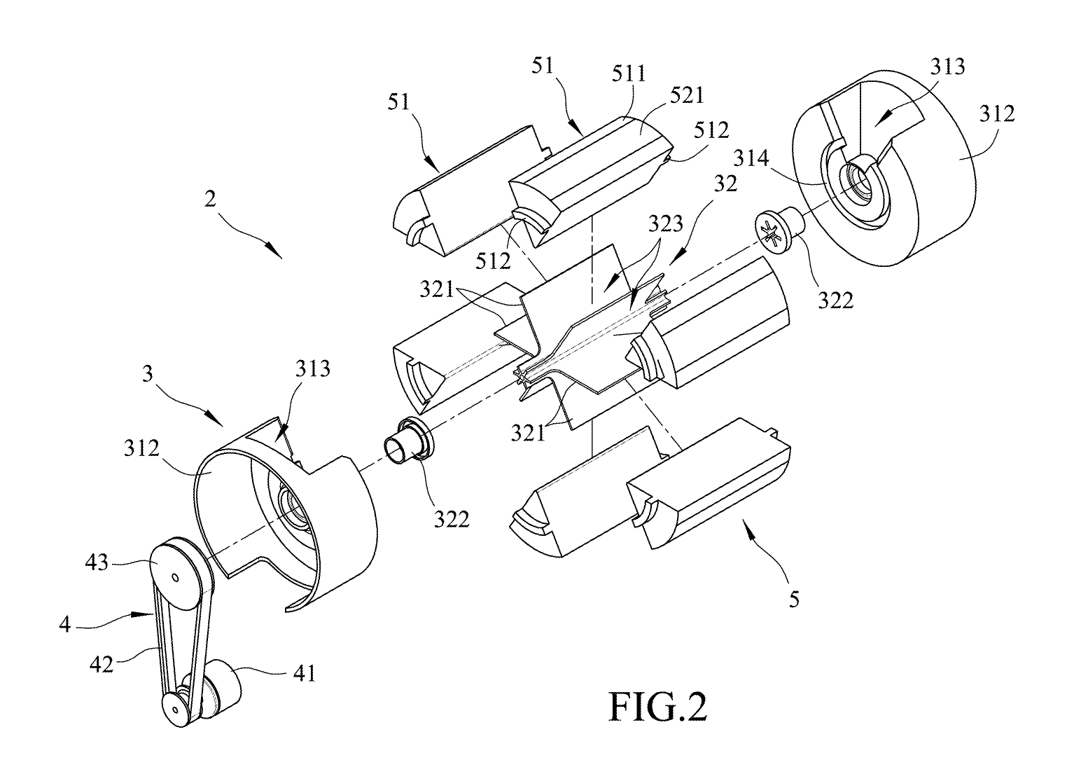

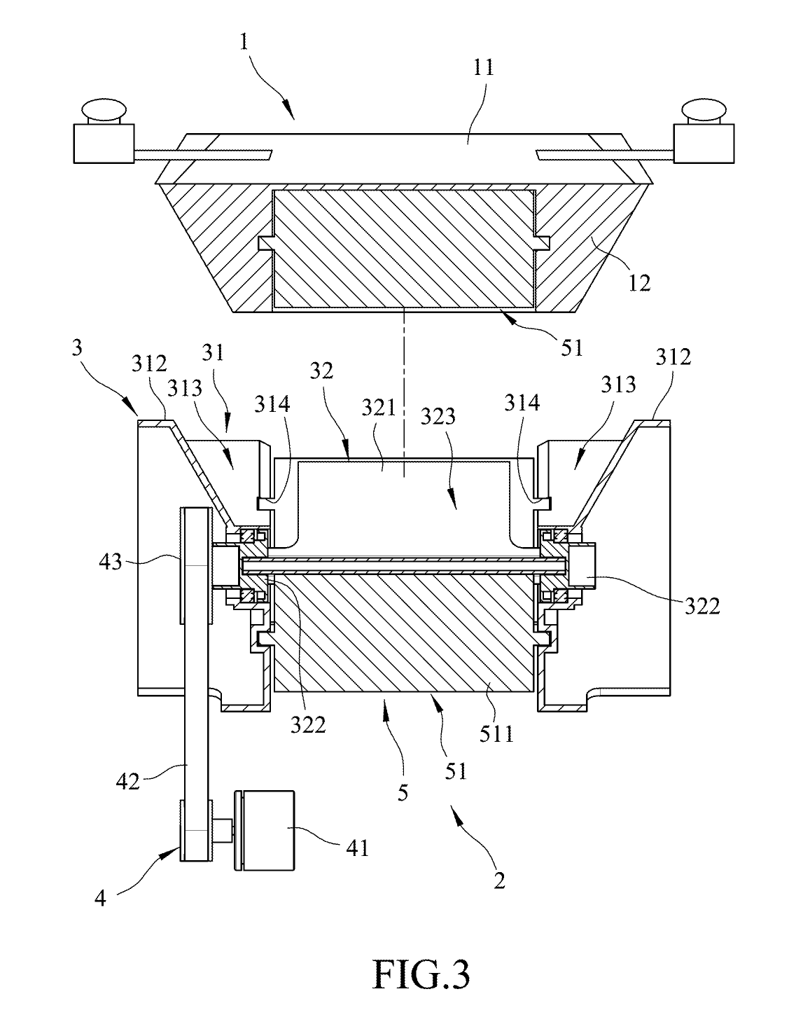

Referring to FIGS. 1 to 3, an embodiment of a power supply exchange system 2 according to the present disclosure is adapted for use with an unmanned aerial vehicle 1. The unmanned aerial vehicle 1 includes a vehicle body 11, and a mounting seat 12 detachably connected to the vehicle body 11. Alternatively, the vehicle body 11 and the mounting seat 12 may be integrally formed as one piece according to practical requirements. The power supply exchange system 2 includes a supporting unit 3, a transmission unit 4 and a power supply unit 5. The supporting unit 3 includes an outer shell 31, and a holding seat 32 that is received in and rotatably connected to the outer shell 31. In this embodiment, the outer shell 31 includes a shell body 311 that defines a connecting opening 310, and two guiding parts 312 to which two opposite ends of the holding seat 32 are respectively and rotatably connected. The shell body 311 receives the guiding parts 312 and the holding seat 32. The shell body 311 is omitted in FIGS. 2 and 3 for illustration purposes. The connecting opening 310 faces upwardly. In this embodiment, the width of the shell body 311 is smaller than distance between any two adjacent rotors of the unmanned aerial vehicle 1, such that there is less air flow influence to the power supply exchange system 2 when the unmanned aerial vehicle 1 is approaching the shell body 311. Each of the guiding parts 312 has a receiving groove 313 that is indented from a top surface of the guiding part 312, that is spatially communicated with the connecting opening 310, and that has a width reduced downwardly. Each of the guiding parts 312 further has an arc guiding slot 314 that is indented from an inner side surface of the guiding part 312 and that is spatially communicated with the receiving groove 313. The holding seat 32 of the supporting unit 3 includes a plurality of angularly spaced apart separating plates 321, and two rotor bushings 322 between which the separating plates 321 are co-rotatably connected. The rotor bushings 322 are respectively and rotatably connected to the guiding parts 312 of the outer shell 31. In this embodiment, the number of the separating plates 321 is six, but can be changed according to practical requirements. Any adjacent two of the separating plates 31 of the holding seat 32 define a receiving slot 323. In other words, the holding seat 32 of the supporting unit 3 defines a plurality of the receiving slots 323 that are angularly spaced apart from each other.

The transmission unit 4 is connected to the outer shell 31, and is operable to drive rotation of the holding seat 32 to align the connecting opening 310 with a selected one of the receiving slots 323. In this embodiment, the transmission unit 4 includes a power source 41 that is disposed in the shell body 311 of the outer shell 31, a pulley 43 that is co-rotatably connected to one of the rotor bushings 322 of the holding seat 32, and a transmission belt 42 that is connected between the power source 41 and the pulley 43. The power source 41 is operable to rotate the pulley 43 through the transmission belt 42. It should be noted that the transmission unit 4 may include a gear set or other mechanisms that can drive rotation of the rotor bushings 322.

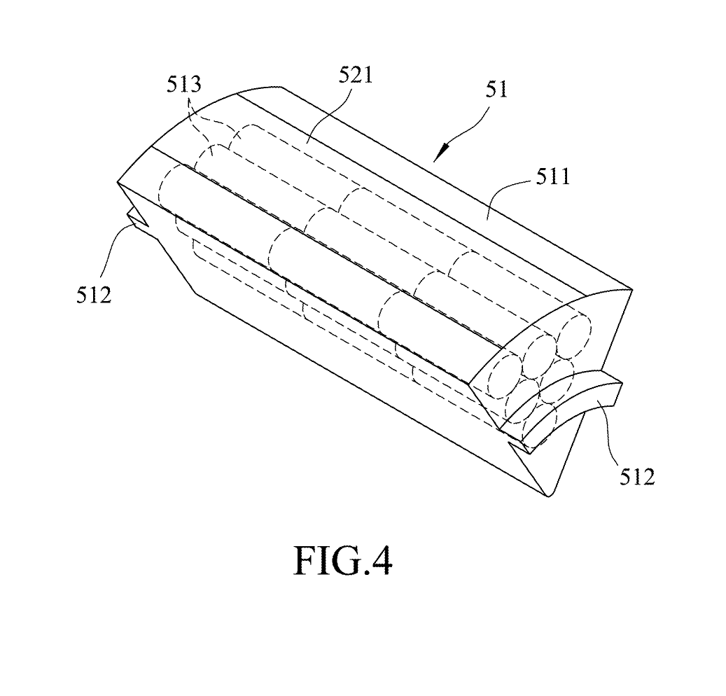

Referring to FIGS. 1, 2 and 4, the power supply unit 5 includes a plurality of energy modules 51 that are detachably and correspondingly received in the receiving slots 323, and a charging module 52 for charging the energy modules 51. Each of the energy modules 51 includes a supporting case 511 that is a fan-shaped column (i.e., having a fan-shaped cross section), two guiding blocks 512 that respectively extend from opposite ends of the supporting case 511, and a plurality of batteries 513 (see FIG. 4) that are received in the supporting case 511. It is worth mentioning that the shape (i.e., fan-shaped column) of the supporting case 511 of each of the energy modules 51 matches the varied-width receiving grooves 313 of the guiding parts 312, facilitating each of the energy modules 51 to be positioned and slide into the corresponding one of the receiving slots 323.

When operating the unmanned aerial vehicle 1, one of the energy modules 51 is adapted to be detachably mounted to the mounting seat 12 of the unmanned aerial vehicle 1 for providing power to the unmanned aerial vehicle 1. In this embodiment, the batteries 513 of the one of the energy modules 51 is used for providing electric power to the unmanned aerial vehicle 1. Each of the batteries 513 is a 21700 battery. A monitoring unit may be provided to the power supply exchange system for monitoring the condition of the batteries 513. The number of the batteries 513 of each of the energy modules 51 may be the multiple of three, which provides the flexibility of series or parallel connections. Alternatively, high pressure gas or fuel tank may be used for providing power to the unmanned aerial vehicle 1.

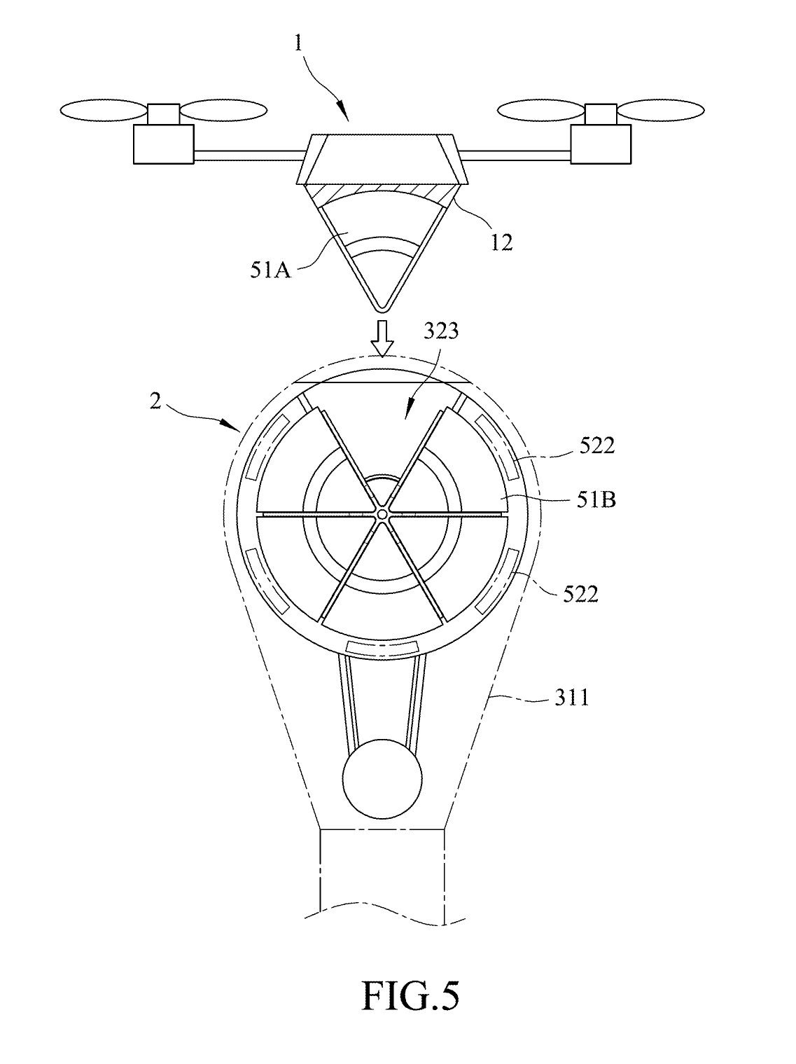

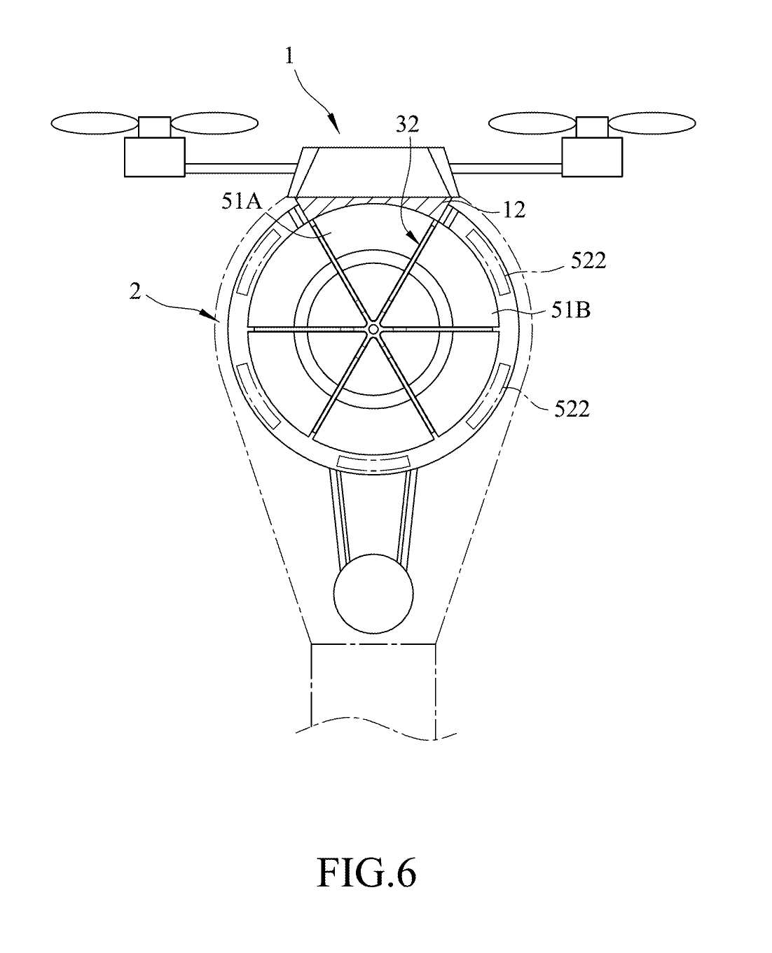

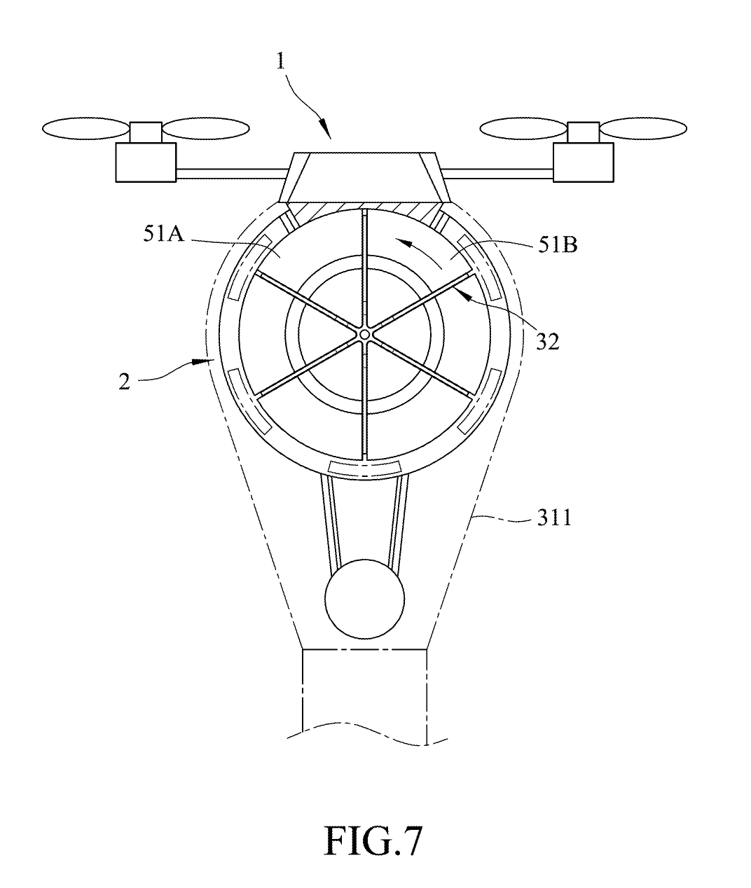

When the power provided by the one of the energy modules 51 is to be consumed, the unmanned aerial vehicle 1 is positioned to allow the mounting seat 12 to be aligned with the connecting opening 310, followed by releasing the one of the energy modules 51 into the corresponding one of the receiving slots 323 (see FIGS. 5 and 6), followed by operating the transmission unit 4 to rotate the holding seat 32 (see FIG. 7) such that another one of the energy modules 51 is aligned with the connecting opening 310 and is adapted to be detachably mounted to the mounting seat 12 of the unmanned aerial vehicle 1 for providing power to the unmanned aerial vehicle 1.

Specifically, each of the energy modules 51 is co-rotatable with the holding seat 32 to move between a charging position, where the guiding blocks 512 of a corresponding one of the energy modules 51 are received in the arc guiding slot 314 and the corresponding one of the energy modules 51 is not exposed from the connecting opening 310, and an engaging position, where the guiding blocks 512 of the corresponding one of the energy modules 51 are not received in the arc guiding slot 314 and the corresponding one of the energy modules 51 is exposed from the connecting opening 310 for connection with the mounting seat 12 of the unmanned aerial vehicle 1.

Referring to FIGS. 1, 2 and 5, the charging module 52 of the power supply unit 5 includes a plurality of first electric conductors 521 that are respectively disposed on and electrically connected to the energy modules 51, and a plurality of second electric conductors 522 that are disposed on an inner surface of the outer shell of the supporting unit 3. Each of the second electric conductors 522 is in electrical contact with a corresponding one of the first electric conductors 521, and is adapted to be electrically connected to an electric power source for supplying electric power to the respective one of the energy modules 51. Specifically, each of the first electric conductors 521 is connected to the supporting case 511 of a respective one of the energy modules 51, and is electrically connected to the batteries 513 of the respective one of the energy modules 51. When the holding seat 32 does not rotate, a spring plate (not shown) of each of the first electric conductors 521 except that of the one of the energy module mounted on the unmanned aerial vehicle 1 is electrically connected to the corresponding one of the second electric conductor 522. In this embodiment, there is only one first electric conductor 521 disposed at the middle of the supporting case 511, and there may, alternatively, be two first electric conductors 521 respectively disposed at opposite sides of the supporting case 511. The number and position of the first electric conductor 521 may be changed according to practical requirements.

A more detailed description of the energy module exchange processes is provided below. Referring to FIGS. 1, 2, 5 and 6, the mounting seat 12 of the unmanned aerial vehicle 1 is mounted with one of the energy modules 51 that needs to be replaced (denoted as 51A in FIGS. 5 to 8) and is aligned with the connecting opening 310 of the power supply exchange system 2. The holding seat 32 is rotated such that an empty receiving slot 323 faces the mounting seat 12 of the unmanned aerial vehicle 1. The unmanned aerial vehicle 1 is then landed and docketed at the power supply exchange system 2 such that the energy module 51A is received in the empty receiving slot 323 and the receiving grooves 313 of the guiding parts 312, followed by releasing the energy module 51A from the mounting seat 12 of the unmanned aerial vehicle 1. It is worth mentioning that, in this embodiment, one of the receiving slots 323 is intentionally left empty for receiving the energy module 51A, and the empty receiving slot 323 is in spatial communication with the connecting opening 310 for expediting the energy module exchange processes.

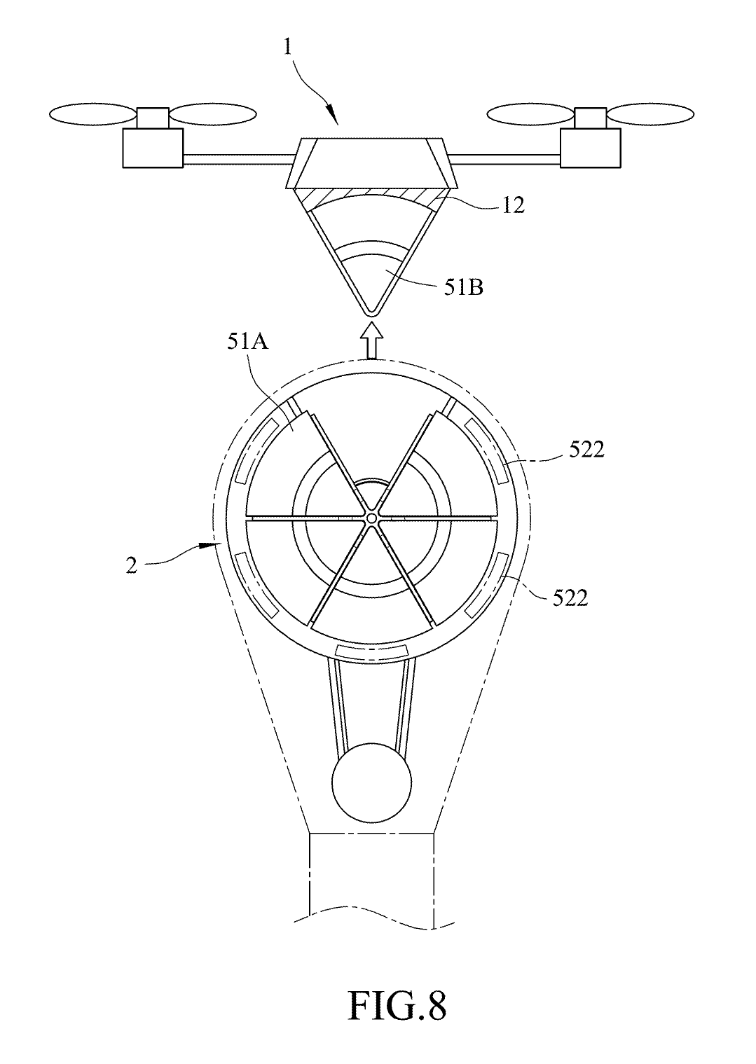

Referring to FIGS. 1, 2, 7 and 8, the holding seat 32 is then operated to rotate counterclockwisely (see FIG. 7) such that the guiding blocks 512 of the energy module 51A enter the arc guiding slot 314 and the energy module 51A is moved from the engaging position to the charging position. Moreover, one of the charged energy modules 51 (denoted as 51B in FIGS. 5 to 8) is moved to the engaging position and is registered with the mounting seat 12 of the unmanned aerial vehicle 1. Subsequently, a fixing mechanism (not shown, e.g., magnetic connection, latch connection, etc.) of the unmanned aerial vehicle 1 is operated to connect the energy module 51B to the mounting seat 12 of the unmanned aerial vehicle 1. Power is then provided to the unmanned aerial vehicle 1 by the energy module 51B, and the unmanned aerial vehicle 1 is operated to undock from the power supply exchange system 2 (see FIG. 8). Meanwhile, the energy module 51A is charged via the charging module 52, and is then ready for being used for subsequent energy module exchange operation. It should be noted that, in this embodiment, the unmanned aerial vehicle 1 is provided with a back-up power source (not shown) for providing power during the energy module exchange processes without the necessity of energizing and de-energizing the unmanned aerial vehicle 1, thereby improving convenience and efficiency.

The power supply exchange system 2 can be deployed at a desired location, and may be shared by multiple unmanned aerial vehicles 1, thereby increasing the service distances of the unmanned aerial vehicles 1, and even achieving completely automated operations.

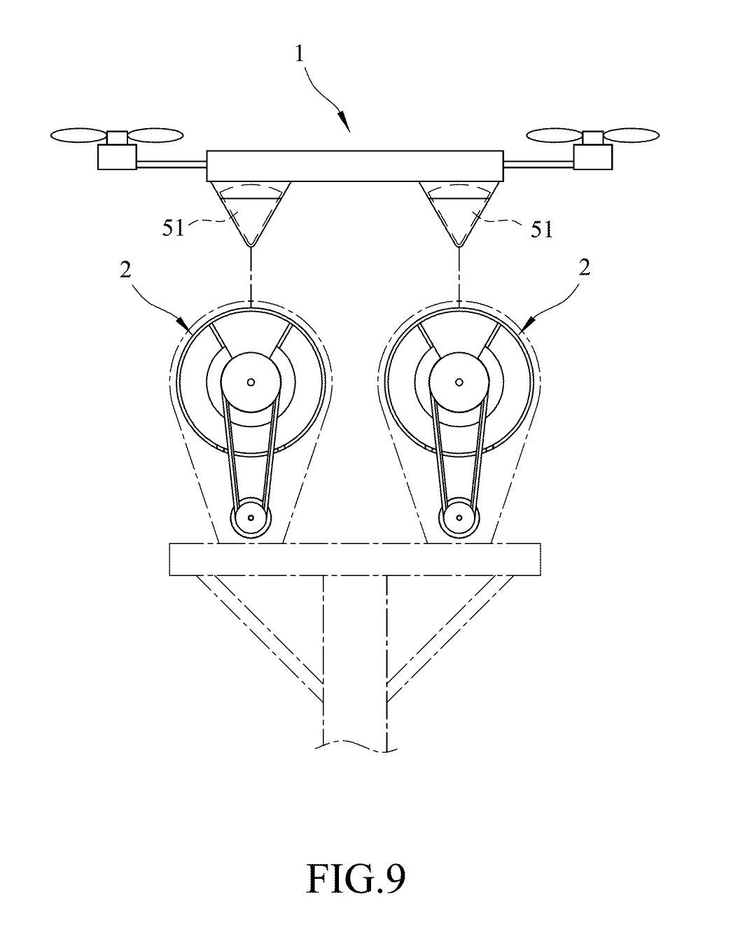

Referring to FIGS. 1, 2 and 9, a variation of the unmanned aerial vehicle 1 includes two of the mounting seats 12, each of which is mounted with one of the energy modules 51. Two of the power supply exchange systems 2 of this disclosure are connected for use with the variation of the unmanned aerial vehicle 1.

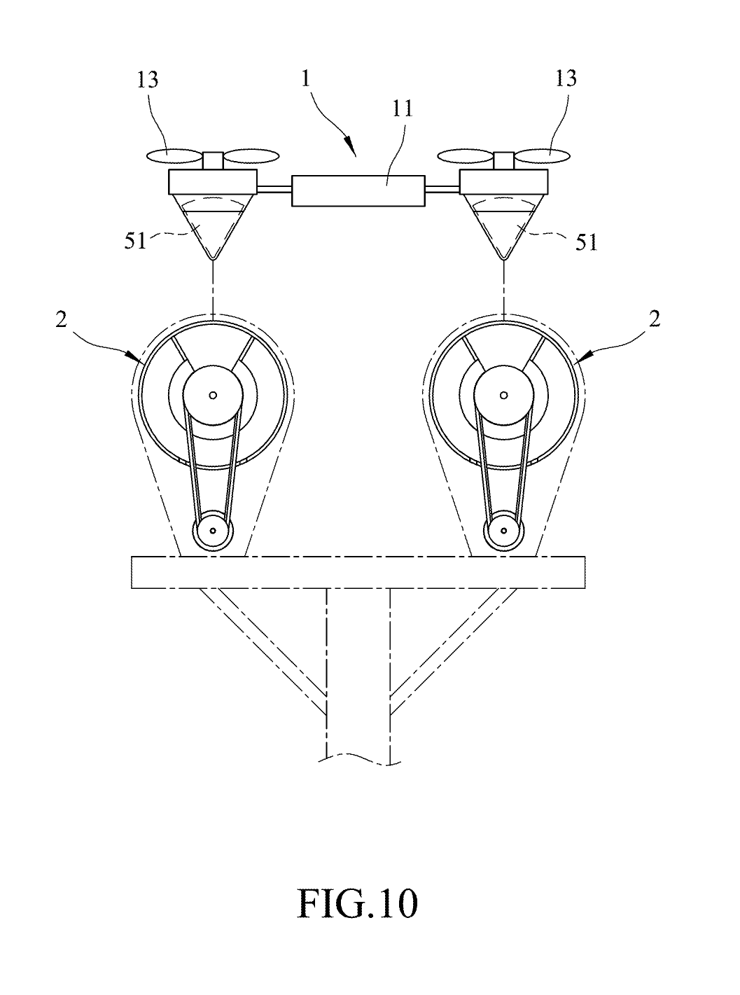

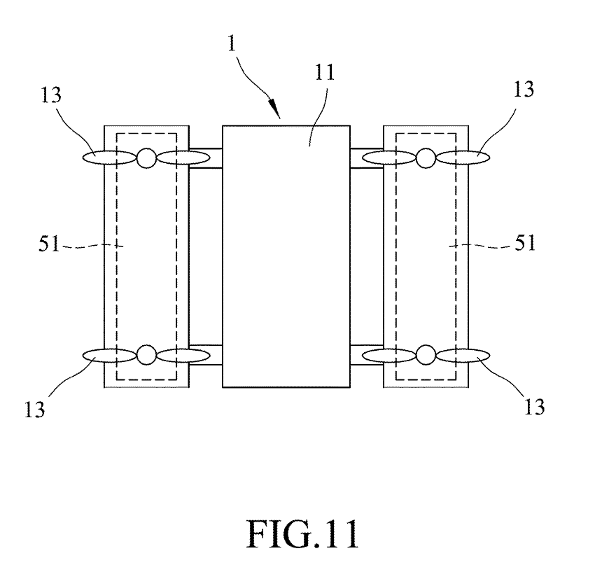

Referring to FIGS. 1, 2, 10 and 11, in another variation, there are four propellers 13 disposed above the vehicle body 11, and the mounting seats 12 are disposed below the propellers 13. Such configuration allows the vehicle body 11 to be used for carrying other components or goods. Moreover, with the mounting seats disposed directly below the propellers 13, the stability of the unmanned aerial vehicle 1 during flying is improved.

To sum up, the power supply exchange system 2 of this disclosure may be provided at desired location for use with the unmanned aerial vehicle 1. The holding seat 32 of the supporting unit 3 of the power supply exchange system 2 allows fast and convenient exchange of the energy modules 51.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment, it is understood that this disclosure is not limited to the disclosed embodiment and variation but is intended to cover various arrangements included within the spirit and scope of the broadest interpretation so as to encompass all such modifications and equivalent arrangements.

What is claimed is:

1. A power supply exchange system adapted for use with an unmanned aerial vehicle including a mounting seat, said power supply exchange system comprising:
a supporting unit including an outer shell that defines a connecting opening, and a holding seat that is rotatably connected to said outer shell and that defines a plurality of angularly spaced apart receiving slots;
a transmission unit connected to said outer shell and operable to drive rotation of said holding seat to align said connecting opening with a selected one of said receiving slots; and
a power supply unit including a plurality of energy modules that are detachably and correspondingly received in said receiving slots,
wherein when operating the unmanned aerial vehicle, one of said energy modules is adapted to be detachably mounted to the mounting seat of the unmanned aerial vehicle for providing power to the unmanned aerial vehicle,
wherein when the power provided by said one of said energy modules is to be consumed, the unmanned aerial vehicle is positioned to allow the mounting seat to be aligned with said connecting opening, followed by releasing said one of said energy modules into a corresponding one of said receiving slots, followed by operating said transmission unit to rotate said holding seat such that another one of said energy modules is aligned with said connecting opening and is adapted to be detachably mounted to the mounting seat of the unmanned aerial vehicle for providing power to the unmanned aerial vehicle.

2. The power supply exchange system as claimed in claim 1, wherein said power supply unit further includes a charging module for charging said energy modules.

3. The power supply exchange system as claimed in claim 2, wherein said charging module of said power supply unit includes a plurality of first electric conductors that are respectively disposed on and electrically connected to said energy modules, and a plurality of second electric conductors that are disposed on an inner surface of said outer shell of said supporting unit, each of said second electric conductors being in electrical contact with a corresponding one of said first electric conductors and being adapted to be electrically connected to an electric power source for supplying electric power to a corresponding one of said energy modules.

4. The power supply exchange system as claimed in claim 3, wherein:
said outer shell of said supporting unit has two guiding parts to which two opposite ends of said holding seat are respectively and rotatably connected;
each of said guiding parts has a receiving groove that is spatially communicated with said connecting opening, and an arc guiding slot that is spatially communicated with said receiving groove;
each of said energy modules includes a supporting case and two guiding blocks that respectively extend from opposite ends of said supporting case;
each of said energy modules is co-rotatable with said holding seat to move between a charging position, where said guiding blocks of a corresponding one of said energy modules are received in said arc guiding slot and the corresponding one of said energy modules is not exposed from said connecting opening, and an engaging position, where said guiding blocks of the corresponding one of said energy modules are not received in said arc guiding slot and the corresponding one of said energy modules is exposed from said connecting opening.

5. The power supply exchange system as claimed in claim 4, wherein each of said energy modules of said power supply unit further includes a plurality of batteries that are received in said supporting case and that are electrically connected to a corresponding one of said first electric conductors, said supporting case of each of said energy modules having a fan-shaped cross section.

6. The power supply exchange system as claimed in claim 5, wherein the number of said batteries of each of said energy modules is the multiple of three.

7. The power supply exchange system as claimed in claim 6, wherein said holding seat of said supporting unit includes a plurality of angularly spaced apart separating plates and two rotor bushings between which said separating plates are connected, said rotor bushings of said holding seat being respectively and rotatably connected to said guiding parts of said outer shell, any adjacent two of said separating plates of said holding seat defining a corresponding one of said receiving slots.

8. The power supply exchange system as claimed in claim 7, wherein said outer shell of said supporting unit includes a shell body that receives said guiding parts and said holding seat, and that defines said connecting opening.

9. The power supply exchange system as claimed in claim 8, wherein said transmission unit includes a power source, a pulley co-rotatably connected to one of said rotor bushings of said holding seat, and a transmission belt that is connected between said power source and said pulley, said power source being operable to rotate said pulley through said transmission belt.
